(19) United States
(12) Patent Application Publication
(10) Pub. No.: US 2003/0023469 A1
(43) Pub. Date: Jan. 30, 2003

(54) System and method for controlling receipt and dispatch of cargo

(76) Inventors: Chun-chih Lee, Tao-Yuan (CN); Sheng-chi Luo, Taipei (TW); Vei Zhang, Shenzhen (CN); Wenbo Mao, Shenzhen (CN); Vun Zhang, Shenzhen (CN)

Correspondence Address: Wei Te (Joseph) Chung, Foxconn International, Inc., 1650 Memorex Drive, Santa Clara, CA, 95050, US

(21) Appl. No.: 09/962,532

(22) Filed: Sep. 21, 2001

(30) Foreign Application Priority Data
Jul. 27, 2001 (TW) 90118474

(51) Int. Cl. G06F 17/60

(52) U.S. Cl. 705/7

(57) ABSTRACT

A system and method for controlling receipt and dispatch of cargo collects information on vehicles (5a, 5b) and cargo being inspected and checks the collected information against database delivery schedules via an electronic communications network (10) in real time. The system comprises a database (6) for storing incoming delivery schedules (62) and outgoing delivery schedules (64), a server (8) for storing records of receipt and dispatch of cargo, weighbridges (3a, 3b) for weighing vehicles loaded with cargo, barriers (15a, 15b) for controlling passage of vehicles through an inspection gate), and control computers (2) for checking data of vehicles and cargo being inspected against corresponding data in the database and the server via the network. Records stored in the server include inspection records (82), vehicle records (84) and inspector records (86). Operation computers (4) are provided to search for and update data in the database and the server via the network.

### BACKGROUND OF THE INVENTION

1. Field of the Invention

This invention relates to means for controlling receipt and dispatch of cargo, and more particularly, to systems and methods that automatically collect information on vehicles and cargo being inspected and check the collected information against database delivery schedules via an electronic communications network in real time.

2. Description of Related Art

As web communications technology has advanced, such technology is increasingly being used to improve the processes of production, procurement and sales. Manufacturing enterprises are facing increasingly tough competition, driving them to speed up production and service to better meet customers' needs. In the field of inspection of cargo, there is still no satisfactory system or method which can streamline the process of inspection by using web technology and networking.

An efficient delivery system is especially useful for large factory premises which may have hundreds of loads of cargo received and dispatched daily. At a large factory, inspection and checking of cargo normally involves complicated physical and manual procedures. Such procedures are particularly prone to human error. In addition, up-to-date data of inspected cargo frequently cannot be obtained in time, and accurate updating of data of inspected cargo is time-consuming and unwieldy.

Conventionally, an inspector inspects cargo according to a hardcopy delivery advice accompanying the cargo and a delivery schedule compiled by the relevant responsible department of the inspector's organization. The delivery schedule may contain information for one day or for several days. In a large factory, the delivery schedule may be too long and complicated to easily locate the desired information. In addition, the delivery schedule is usually compiled several days before the actual inspection day. Consequently the delivery schedule does not include last-minute changes, and this frequently causes confusion and mistakes.

Moreover, because conventional inspection procedures are largely manual, inspection results are generally checked by the factory's auditors only after all inspections for one day have been completed. As a result, auditors cannot obtain real time inspection information and cannot promptly respond to any anomalies that they may fined.

Another problem many factories encounter in procurement is when suppliers do not deliver in time or in accordance with applicable supply contracts. In such instances, the factory may either accept the cargo at a discount price or alternatively refuse to accept the cargo and subsequently claim against the supplier. However, there is no known system that can strictly control delivery of cargo in such circumstances.

Accordingly, what is needed is a system and method that can integrate in a unified network delivery information needed for inspecting incoming and outgoing cargo. What is also needed is a system and method that enables authorized users to search for real time inspection information, and to update delivery schedule and inspection records in real time.

### SUMMARY OF THE INVENTION

A primary object of the present invention is to provide an inspection controlling system for collecting information on vehicles and cargo being inspected and checking the collected information against database delivery schedules via an electronic communications network in real time.

Another object of the present invention is to provide an inspection controlling method for collecting information on vehicles and cargo being inspected and checking the collected information against database delivery schedules via an electronic communications network in real time.

Still another object of the present invention is to provide an inspection controlling system which enables authorized users to search for real time inspection information and to update delivery schedule and inspection records in real time.

The present invention achieves the above objects and solves the foregoing problems by providing a system for controlling delivery of cargo and providing a method for using the same.

In one aspect of the present invention, a system collects information on vehicles and cargo being inspected and checks the collected information against database delivery schedules via an electronic communications network in real time. The system comprises a database for storing incoming delivery schedules and outgoing delivery schedules, a server for storing records of receipt and dispatch of cargo, a couple of weighbridges for weighing vehicles loaded with cargo, a couple of barriers for controlling passage of vehicles through an inspection gate, and a couple of control computers for checking data of vehicles and cargo being inspected against corresponding data in the database and the server. Records stored in the server include inspection records, vehicle records and inspector records. A plurality of operation computers is provided to search for and update data in the database and the server via the network.

In another aspect of the invention, there is provided a method for controlling incoming delivery of cargo, comprising the steps of: inputting an incoming delivery schedule from a operation computer into a database; inputting a vehicle record and an operator record from the operation computer into a server; checking information about an incoming vehicle loaded with cargo against the incoming delivery schedule and the vehicle record by using at least one control computer connected to the database and the server; and permitting the incoming vehicle to pass when the information about the incoming vehicle matches the incoming delivery schedule and the vehicle record.

In yet another aspect of the invention, there is provided a method for controlling outgoing delivery of cargo, comprising the steps of: inputting an outgoing delivery schedule from an operation computer into a database; inputting a vehicle record and an operator record from the operation computer into a server; checking information about an outgoing vehicle loaded with cargo against the outgoing delivery schedule and the vehicle record by using at least one control computer connected to the database and the server; and permitting the outgoing vehicle to pass when the information about the outgoing vehicle matches the outgoing delivery schedule and the vehicle record.

These and other objects, features, and advantages of the present invention will become more fully apparent from the following description and appended claims, or may be learned by practice of the invention as set forth hereinafter.

### BRIEF DESCRIPTION OF THE DRAWINGS

The invention will be described and explained with additional specificity and detail in conjunction with the accompanying drawings, in which:

FIG. 1 is a schematic diagram of inspection gate premises that implement a system and method for controlling receipt and dispatch of cargo in accordance with a preferred embodiment of the present invention;

FIG. 2 is a schematic diagram of the system and method for controlling receipt and dispatch of cargo in accordance with the preferred embodiment of the present invention;

FIG. 3 is a flowchart of information flow of the system and method of the preferred embodiment of FIG. 2;

FIG. 4 is a flowchart of inspection of an incoming vehicle and its cargo at the inspection gate premises of FIG. 1, according to the system and method of the preferred embodiment of FIG. 2; and

FIG. 5 is a flowchart of inspection of an outgoing vehicle and its cargo at the inspection gate premises of FIG. 1, according to the system and method of the preferred embodiment of FIG. 2.

### DETAILED DESCRIPTION OF THE INVENTION

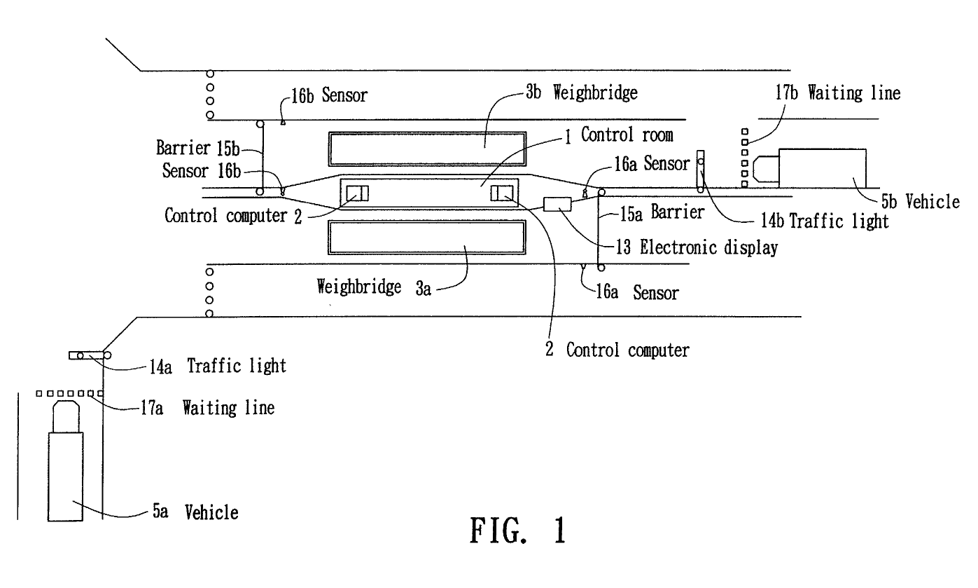

FIG. 1 is a schematic diagram of inspection gate premises incorporating a system and method for controlling receipt and dispatch of cargo in accordance with a preferred embodiment of the present invention. The inspection gate premises may be at a vehicular entrance at a boundary of a factory's premises. The inspection gate premises comprise an inspection gate at which incoming and outgoing vehicles and cargo are inspected by inspectors. The vehicles are allowed to enter or leave the factory premises only if they meet predetermined passage conditions.

The inspection gate premises comprise a control room 1 in which a plurality of control computers 2 are provided. By using the control computers 2, operators in the control room 1 can check vehicle and cargo information and control other devices in the inspection gate premises. In the preferred embodiment, such devices include a couple of barriers 15a, 15b and a couple of traffic lights 14a, 14b. An electronic display 13 is located in front of the control room 1. The display 13 receives information on vehicles 5a, 5b and their cargo from the control computers 2, and shows such information on a display screen.

The barriers 15a, 15b are normally closed, to ensure that the vehicles 5a, 5b do not pass through the inspection gate premises until the vehicles 5a, 5b and their cargo have been fully inspected and found to meet the passage conditions. A vehicle 5a loaded with incoming cargo firstly waits behind a waiting line 17a. After the traffic light 14a turns from red to green, the vehicle 5a enters the inspection gate premises. A weighbridge 3a weighs the vehicle 5a, and a sensor 16a automatically detects information on the vehicle 5a from an IC board (not shown) pre-installed in the vehicle 5a. If information on the vehicle 5a and its cargo meets the passage conditions, the barrier 15a will be opened and the vehicle 5a will be allowed to pass through.

Similarly, a vehicle 5b loaded with outgoing cargo waits behind a waiting line 17b. After the traffic light 14b turns from red to green, the vehicle 5b enters the inspection gate premises. A weighbridge 3b weighs the vehicle 5b, and a sensor 16b automatically detects information on the vehicle 5b from an IC board (not shown) pre-installed in the vehicle 5b. If information on the vehicle 5b and its cargo meets the passage conditions, the barrier 15b will be opened and the vehicle 5b will be allowed to pass through.

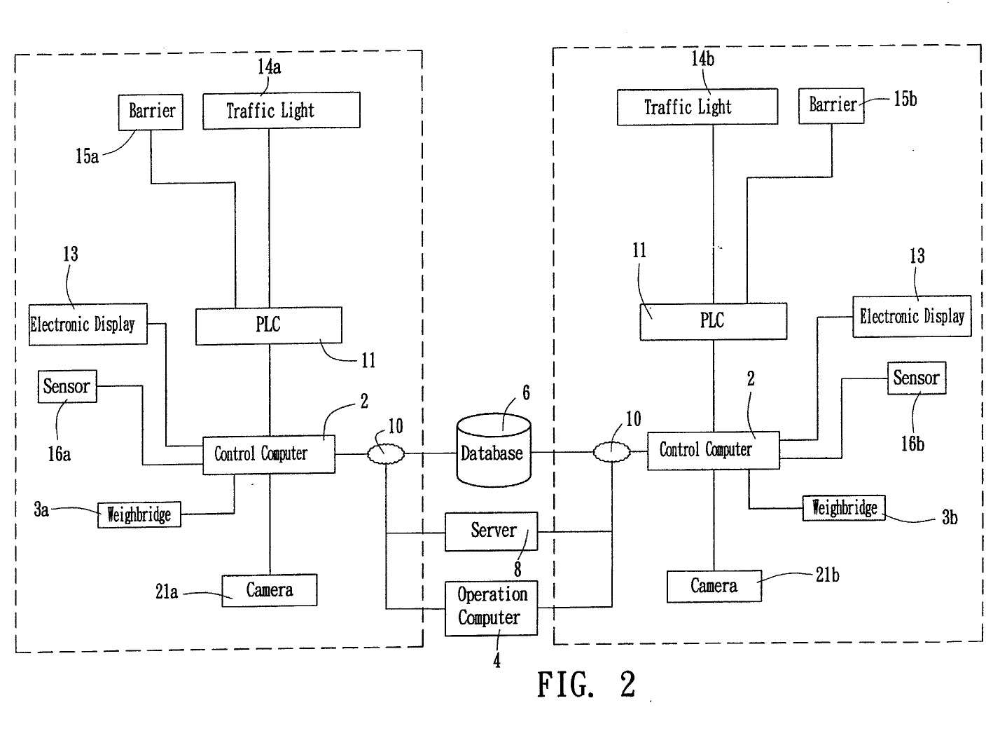

FIG. 2 is a schematic diagram of the system and method for controlling receipt and dispatch of cargo in accordance with the preferred embodiment of the present invention. The diagram comprises two major parts, each part being framed by broken lines. One part shows devices for inspecting vehicles 5a and cargo received into the factory, and the other part shows devices for inspecting vehicles 5b and cargo dispatched out from the factory. The two parts are almost identical. Therefore, description of one part herein can be interpreted to include description of the other part also.

The preferred embodiment of the present invention comprises at least one control computer 2 in each part. Each control computer 2 is connected to a database 6 via a network 10, and can obtain receipt information and dispatch information from the database 6. The database 6 can be connected to another system in the factory, such as a production management system which stores receipt information and dispatch information.

The preferred embodiment of the present invention further comprises a server 8 for storing information on vehicles, inspectors, and cargo delivery. The control computers 2 are connected to the server 8, and can obtain needed information from the server 8 via the network 10. A plurality of operation computers 4 (only one shown) is provided for searching for and updating data in the server 8 and the database 6, and for selecting needed data via the network 10.

A plurality of other devices in the preferred embodiment of the present invention are connected to and can interchange information with the control computers 2. Such devices include the weighbridges 3a, 3b (see FIG. 1), the electronic display 13, the sensors 16a, 16b, and a couple of closed-circuit cameras 21a, 21b. The electronic display 13 obtains information on the vehicles 5a, 5b and cargo to be inspected from the control computers 2, and displays the information on a display screen. Inspectors can then physically check the vehicles 5a, 5b and their cargo according to the information shown on the screen. Referring to the left-hand part of FIG. 2, the weighbridge 3a weighs the vehicle 5a loaded with incoming cargo. The weighbridge 3a automatically transmits a resulting measured weight to the control computer 2. The control computer 2 then transfers the measured weight to the server 8, where the measured weight is stored as a record of cargo receipt. The camera 21a can shoot the whole procedure of physical cargo inspection, and can transmit a real time view of the procedure to the control computer 2.

The preferred embodiment of the present invention further comprises a couple of programmable logic controllers (PLCs) 11. The PLCs 11 connect the barriers 15a, 15b and the traffic lights 14a, 14b with the control computers 2, and translate a variety of communicative signals passing therebetween. Referring to the left part of FIG. 2, the control computer 2 can control the barrier 15a and the traffic light 14a via the PLC 11. The control computer 2 can accordingly allow or prohibit passage of the vehicle 5a.

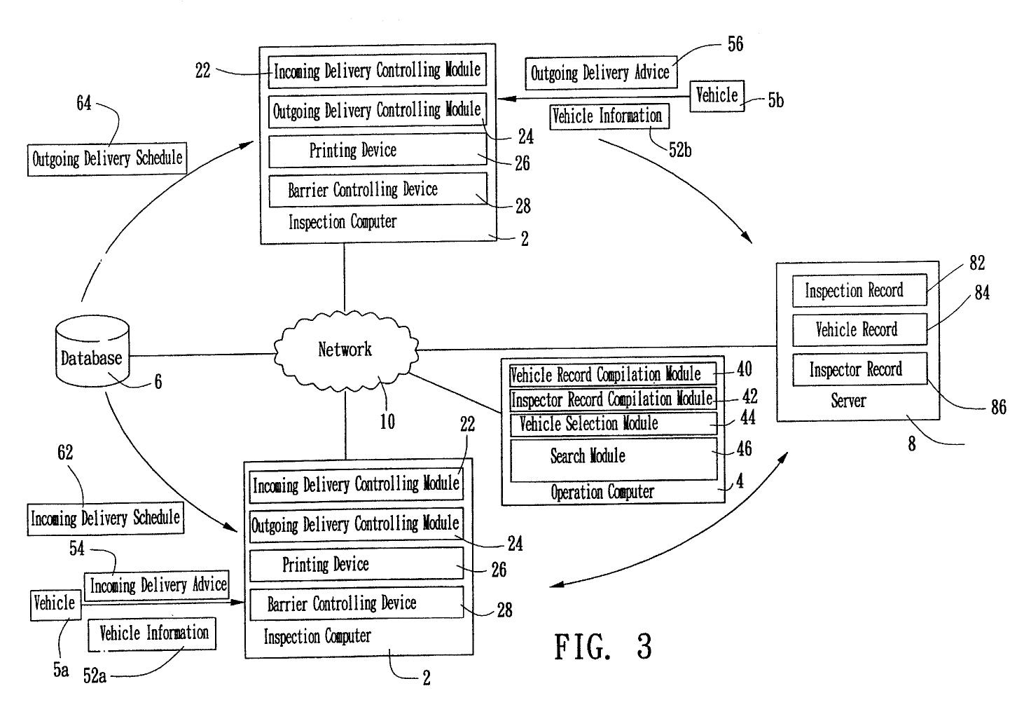

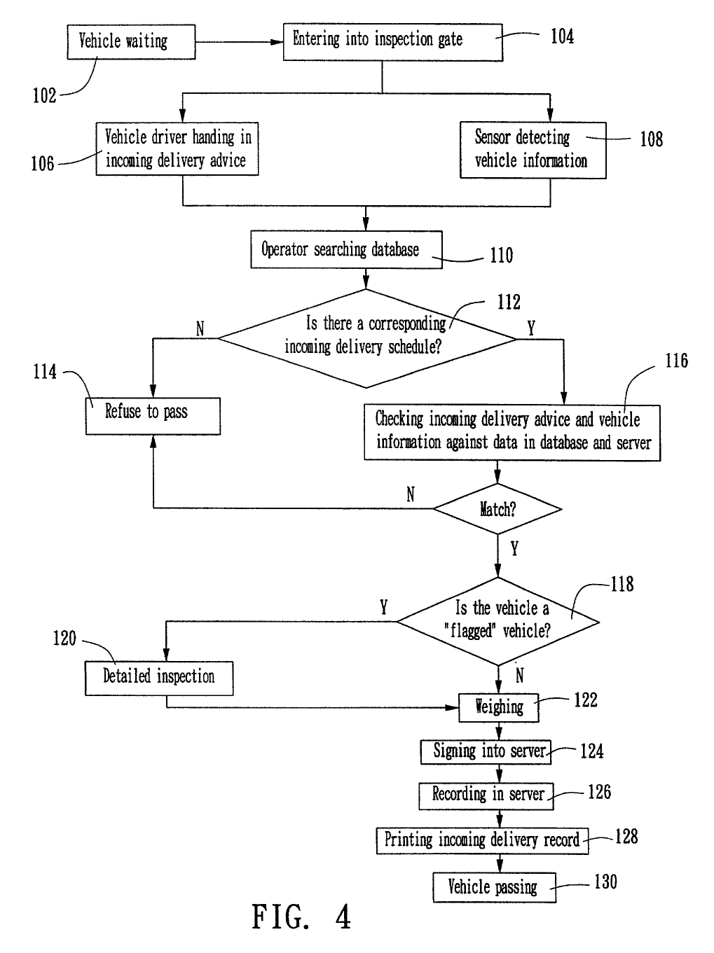

FIG. 3 shows information flow of the system and method of the preferred embodiment of the present invention. The control computer 2 comprises a receipt controlling module 22, a dispatch controlling module 24, a printing device 26 and a barrier controlling device 28. The receipt controlling module 22 controls cargo received. When the vehicle 5a enters the inspection gate premises, a driver of the vehicle 5a hands a hardcopy incoming delivery advice 54 to an inspector, and the sensor 16a automatically detects vehicle information 52a from the IC board of the vehicle 5a. The incoming delivery advice 54 comprises a set of information about the vehicle 5a and its cargo, including an incoming delivery advice number, vehicle registration number, supplier code, name of the cargo, quantity of cargo, and delivery date. Where appropriate, the cargo in the vehicle 5a can be detailed in a plurality of incoming delivery advices 54. The vehicle information 52a includes basic information concerning the vehicle 5a, such as vehicle registration number, owner's name, and driver's name. When inspecting the vehicle 5a, the inspector collects the information contained in the incoming delivery advice 54 and the vehicle information 52a. The inspector then checks the collected information against an incoming delivery schedule 62 stored in the database 6. A detailed description of such checking is given in the description relating to FIG. 4 that follows.

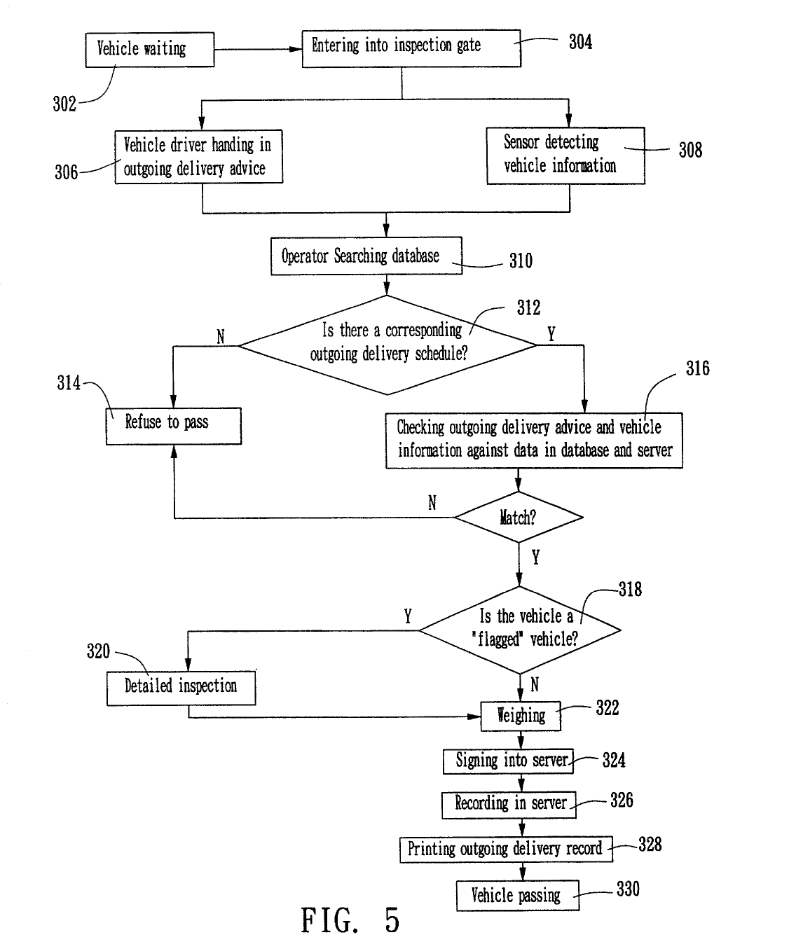

The dispatch controlling module 24 controls cargo dispatched. When the vehicle 5b enters the inspection gate premises, a driver of the vehicle 5b hands a hardcopy outgoing delivery advice 56 to an inspector, and the sensor 16b automatically detects vehicle information 52b from the IC board of the vehicle 5b. The outgoing delivery advice 56 comprises a set of information about the cargo, including an outgoing delivery advice number, vehicle number, department code, name of the cargo, quantity of cargo, and delivery date. Where appropriate, the cargo in the vehicle 5b can be detailed in a plurality of outgoing delivery advices 56. The vehicle information 52b includes basic information concerning the vehicle 5b, such as vehicle registration number, owner's name, and driver's name. When inspecting the vehicle 5b, the inspector collects the information contained in the outgoing delivery advice 56 and the vehicle information 52b. The inspector then checks the collected information against an outgoing delivery schedule 64 stored in the database 6. A detailed description of such checking is given in the description relating to FIG. 5 that follows. The printing device 26 may be a conventional printing machine utilized to print records of cargo received and dispatched. The barrier controlling device 28 is connected to the PLC 11, and can control the traffic lights 14a, 14b and the barriers 15a, 15b.

The database 6 may be an external system, such as a production management system, that stores the incoming delivery schedule 62 and the outgoing delivery schedule 64. The incoming delivery schedule 62 includes a receipt advice number, delivery date, vehicle registration number, supplier code, name of cargo, and quantity. The outgoing delivery schedule 64 includes an outgoing delivery advice number, delivery date, vehicle registration number, department code, name of cargo, and quantity.

The server 8 comprises an inspection record 82, a vehicle record 84, and an inspector record 86. The inspection record 82 includes inspection results of the vehicles 5a, 5b and cargo received and dispatched. Such results include receipt and outgoing delivery advice numbers, vehicle registration numbers, receipt times, dispatch times, cargo weights, and inspectors. The vehicle record 84 includes basic information on the vehicles 5a, 5b, such as vehicle registration numbers, types of vehicles, and owner's names. The inspector record 86 includes basic information on inspectors, including names, employee numbers and areas of the system that the respective inspectors are authorized to access.

The operation computer 4 is provided for users to input data into the server 8, and to search for information in the database 6, the server 8 and the control computer 2. The operation computer 4 comprises a vehicle record compilation module 40, an inspector record compilation module 42, a cargo selection module 44 and a search module 46. The vehicle record compilation module 40 can add, delete and update the vehicle records 84 in the server 8. The inspector record compilation module 42 can compile the inspection records 82 in the server 8. The cargo selection module 44 is provided to select and flag important cargo detailed in any incoming delivery schedule 62 and any outgoing delivery schedule 64. Cargo flagged in an incoming delivery schedule 62 or an outgoing delivery schedule 64 means that the actual physical cargo should be thoroughly inspected before it passes through the inspection gate premises. The search module 46 is provided to search information in the database 6, the server 8 and the control computer 2. Users can only access modules that they are specifically authorized to access.

FIG. 4 is a flowchart of inspection of an incoming vehicle 5a and its cargo at the inspection gate premises, according to the system and method of the preferred embodiment of the present invention.

A large factory may have hundreds of loads of cargo received and dispatched daily. Accordingly, in step 102, the vehicle 5a loaded with cargo waits behind the waiting line 17a before it enters the inspection gate premises. In step 104, after the traffic light 14a turns from red to green, the vehicle 5a enters the inspection gate premises. In steps 106 and 108, the driver of the vehicle 5a hands the incoming delivery advice 54 to the operator in the control room 1, and the sensor 16a automatically detects the vehicle information 52a from the IC board of the vehicle 5a. In step 110, the operator searches for and obtains the incoming delivery schedule 62 in the database 6. In step 112, the operator checks the incoming delivery advice 54 and the vehicle information 52a against the incoming delivery schedule 62. If the incoming delivery schedule 62 does not correspond to the incoming delivery advice 54 or the vehicle information 52a, then in step 114, the operator refuses the vehicle 5a permission to pass through and notifies the relevant responsible party. If the incoming delivery schedule 62 corresponds to the incoming delivery advice 54 and the vehicle information 52a, then in step 116, the operator checks all details of the incoming delivery advice 54 and the vehicle information 52a against all details of the incoming delivery schedule 62. If the details do not match, then in step 114, the operator refuses the vehicle 5a permission to pass through and notifies the relevant responsible party. If the details match, then in step 118, the operator checks the database 6 to ascertain whether the cargo has been specially flagged for thorough physical inspection. Such flagging may have been done by an authorized user of the system. If the cargo has been flagged, then in step 120, the vehicle 5a is guided to a designated place for thorough physical inspection of its cargo. If the cargo has not been flagged, then in step 122, the vehicle 5a is weighed on the weighbridge 3a. The measured weight is automatically input into the server 8. In step 124, the operator digitally signs into the server 8 to confirm that all information is correct and that the cargo is allowed to pass. In steps 126 and 128, the operator updates the information on the incoming delivery schedule 62 in the database 6, and prints out a receipt record of the cargo. Then in step 130, the vehicle 5a is allowed to pass through the barrier 15a.

Similarly, FIG. 5 is a flowchart of inspection of an outgoing vehicle 5b and its cargo at the inspection gate premises according to the system and method of the preferred embodiment of the present invention. In step 302, the vehicle 5b loaded with cargo waits behind the waiting line 17b before it enters the inspection gate premises. In step 304, after the traffic light 14b turns from red to green, the vehicle 5b enters the inspection premises. In steps 306 and 308, the driver of the vehicle 5b hands the outgoing delivery advice 56 to the operator in the control room 1, and the sensor 16b automatically detects the vehicle information 52b from the IC board of the vehicle 5b. In step 310, the operator searches for and obtains the outgoing delivery schedule 64 in the database 6. In step 312, the operator checks the outgoing delivery advice 56 and the vehicle information 52b against the outgoing delivery schedule 64. If the outgoing delivery schedule 64 does not correspond to the outgoing delivery advice 56 or the vehicle information 52b, then in step 314, the operator refuses the vehicle 5b permission to pass through and notifies the relevant responsible party. If the outgoing delivery schedule 64 corresponds to the outgoing delivery advice 56 and the vehicle information 52b, then in step 316, the operator checks all details of the outgoing delivery advice 56 and the vehicle information 52b against all details of the outgoing delivery schedule 64. If the details do not match, then in step 114, the operator refuses the vehicle 5b permission to pass through and notifies the relevant responsible party. If the details match, then in step 318, the operator checks the database 6 to ascertain whether the cargo has been specially flagged for thorough physical inspection. Such flagging may have been done by an authorized user of the system. If the cargo has been flagged, then in step 320, the vehicle 5b is guided to a designated place for thorough physical inspection of its cargo. If the cargo has not been flagged, then in step 322, the vehicle 5b is weighed on the weighbridge 3b. The measured weight is automatically input into the server 8. In step 324, the operator digitally signs into the server 8 to confirm that all information is correct and that the cargo is allowed to pass. In steps 326 and 328, the operator updates the information on the outgoing delivery schedule 64 in the database 6, and prints out an outgoing delivery record of the cargo. Then in step 330, the vehicle 5b is allowed to pass through the barrier 15b.

The embodiment described herein is merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims which follow and their equivalents.

What is claimed is:

1. A system for controlling receipt and dispatch of cargo, the system comprising:
a database for storing incoming delivery schedules and outgoing delivery schedules;
a server for storing records of receipt and dispatch of cargo;
a weighbridge for weighing incoming vehicles and outgoing vehicles loaded with cargo;
a barrier for controlling passage of cargo through an inspection gate; and
a control computer for checking data of cargo actually received and dispatched against corresponding data in the database and the server.

2. The system as claimed in claim 1, wherein each incoming vehicle provides at least one incoming delivery advice, each incoming delivery advice providing information selected from the group consisting of incoming delivery advice number, delivery date, vehicle number, supplier code, cargo name and quantity of cargo.

3. The system as claimed in claim 1, wherein each incoming vehicle and each outgoing vehicle respectively has an IC board storing basic vehicle information selected from the group consisting of vehicle registration number, name of owner, and name of driver.

4. The system as claimed in claim 1, further comprising at least one sensor for automatically detecting the basic vehicle information from the IC board.

5. The system as claimed in claim 1, wherein each outgoing vehicle includes at least one outgoing delivery advice, each outgoing delivery advice providing information selected from the group consisting of outgoing delivery advice number, delivery date, vehicle number, department code, cargo name and quantity of cargo.

6. The system as claimed in claim 1, further comprising at least one operation computer providing means for searching for and updating data in the server and the database.

7. The system as claimed in claim 6, wherein each operation computer further comprises means for selecting and flagging a record in any incoming delivery schedule in the database, and means for selecting and flagging a record in any outgoing delivery schedule in the database.

8. The system as claimed in claim 1, wherein the control computer can obtain data in the database and data in the server via an electronic communications network.

9. The system as claimed in claim 8, wherein the electronic communications network includes items selected from the group consisting of the Internet and at least one intranet.

10. A method for controlling receipt of cargo, the method comprising the steps of:
inputting an incoming delivery schedule from an operation computer into a database;
inputting a vehicle record and an operator record from the operation computer into a server;
checking information about an incoming vehicle loaded with cargo against the incoming delivery schedule and the vehicle record by using at least one control computer connected to the database and the server;
permitting the incoming vehicle to pass when the information about the incoming vehicle and cargo matches the incoming delivery schedule and the vehicle record.

11. The method as claimed in claim 10, further comprising the step of:
automatically detecting the information about the incoming vehicle from an IC board installed in the incoming vehicle, and inputting the detected information into the control computer.

12. The method as claimed in claim 10, further comprising the step of:
weighing the incoming vehicle and automatically inputting a resultant measured weight into the control computer.

13. The method as claimed in claim 10, further comprising the step of:
flagging the incoming delivery schedule to indicate that at least one vehicle loaded with cargo should be specially inspected;

14. The method as claimed in claim 13, further comprising the step of:
checking the incoming delivery schedule to ascertain whether the incoming vehicle has been flagged in the incoming delivery schedule.

15. The method as claimed in claim 14, further comprising the step of:
forwarding any flagged vehicle to a designated place for special inspection.

16. The method as claimed in claim 10, further comprising the step of:
digitally signing into the server to confirm passage of the incoming vehicle, and printing an incoming delivery record.

17. A method for controlling dispatch of cargo, the method comprising the steps of:
inputting an outgoing delivery schedule from an operation computer into a database;
inputting a vehicle record and an operator record from the operation computer into a server;
checking information about an outgoing vehicle loaded with cargo against the outgoing delivery schedule and the vehicle record by using at least one control computer connected to the database and the server;
permitting the outgoing vehicle to pass when the information about the outgoing vehicle and cargo matches the outgoing delivery schedule and the vehicle record.

18. The method as claimed in claim 17, further comprising the step of:
flagging the outgoing delivery schedule to indicate that at least one vehicle loaded with cargo should be specially inspected;

19. The method as claimed in claim 18, further comprising the step of:
checking the outgoing delivery schedule to ascertain whether the outgoing vehicle has been flagged in the outgoing delivery schedule.

20. The method as claimed in claim 17, further comprising the step of:
digitally signing into the server to confirm passage of the outgoing vehicle, and printing an outgoing delivery record.

21. A method of controlling cargo carried by a vehicle, comprising the steps of:
providing a database storing a already transferred delivery schedule;
providing an examination gate;
having a vehicle approach the examination gate;
having a driver of the vehicle hand in a delivery advice;
providing a sensor around the gate to detect vehicle information installed in an electronic device built within the vehicle;
check both the delivery advice and the vehicle information with said delivery schedule; and
weighing the vehicle and allowing the vehicle to pass if all the delivery advice, the vehicle information and the delivery schedule are matched with one another.
